(19) United States
(12) Patent Application Publication
(10) Pub. No.: US 2017/0334056 A1
(43) Pub. Date: Nov. 23, 2017

(54) ELECTRIC TOOL

(71) Applicant: MAKITA CORPORATION, Anjo-shi, Aichi (JP)

(72) Inventors: Takahiro KAWAKAMI, Anjo-shi (JP); Yonosuke AOKI, Anjo-shi (JP)

(73) Assignee: MAKITA CORPORATION, Anjo-shi, Aichi (JP)

(21) Appl. No.: 15/524,059

(22) PCT Filed: Oct. 26, 2015
(86) PCT No.: PCT/JP2015/080095

§ 371 Date: May 3, 2017

(30) Foreign Application Priority Data
Nov. 5, 2014 (JP) 2014-224954

(51) Int. Cl. B25F 5/02; B24B 23/02; B25F 5/00

(52) U.S. Cl. CPC B25F 5/02; B25F 5/008; B24B 23/028; B25F 5/006

(57) ABSTRACT

A disc grinder includes a tool main body that may include, for example, as from the front side, a drive portion, a handle portion, and a battery attachment portion. A rechargeable battery may be attached to the battery attachment portion through sliding. A brushless DC motor rotationally drives a motor shaft by electric power from the rechargeable battery. A reduction gear unit may reduce in speed the rotational drive of the motor shaft and may transmit the rotational drive to an output shaft to which a grinding wheel is mounted. The brushless DC motor and a reduction gear of the reduction gear unit may be arranged such that the rotational axis of the motor shaft and the rotational axis of the output shaft are parallel to each other.

### CROSS REFERENCE TO RELATED APPLICATIONS

The present applications is a national phase application corresponding to PCT/JP2015/080095 claiming priority to Japanese Patent Application No. 2014-224954 filed Nov. 5, 2014, which is incorporated herein by reference in its entirety.

### BACKGROUND

### Field of the Invention

The present disclosure relates to an electric tool that is held by hand during the operation.

### Description of the Related Art

Conventionally, as an electric tool held by hand during the operation, there has been known, for example, a disc grinder as disclosed in Japanese Laid-Open Patent Publication No. 2014-148020. This disc grinder includes an electric motor disposed therein as the drive source. An outer housing has a grip portion to be grasped by the operator. At the front portion of the tool, there is arranged a gear head including a bevel gear disposed therein, and attached to the rear portion of the tool is a detachable rechargeable battery as the supply power source. Set to the bevel gear is an output shaft to which a rotational drive force is transmitted from the electric motor. An output axis of the output shaft (the rotational axis of a grinding wheel) is perpendicular to the axis of a motor drive shaft of the electric motor.

A circular grinding wheel as an end tool is mounted to a leading end of the above-mentioned output shaft. The grinding wheel rotated by the output shaft is caused to be applied to a grinding object to grind the grinding object. In this process, it is desirable that the rotating grinding wheel is properly applied to the grinding object. That is, in this kind of disc grinder, it is desirable that the center of gravity of the tool is determined taking the tool operability into consideration so that the rotating grinding wheel is properly applied to the grinding object.

There has been a need in the art for an electric tool that is held by hand during the operation and is improved in the tool operability so that a rotating end tool is properly applied to an object to be worked.

### SUMMARY

In one aspect according to the present disclosure, an electric tool may comprise a battery attachment portion to which a rechargeable battery is attached through sliding, an electric motor rotationally driving a motor shaft by electric power from the rechargeable battery, and a reduction gear reducing in speed the rotational drive of the motor shaft and transmitting the rotational drive to an output shaft to which an end tool is mounted. An arrangement relationship between the electric motor and the reduction gear may be set such that a rotational axis of the motor shaft extends in a same direction as a direction in which a rotational axis of the output shaft extends.

Due to setting the arrangement relationship between the electric motor and the reduction gear such that the rotational axis of the motor shaft extends in the same direction as the direction in which the rotational axis of the output shaft extends, the distance between the motor shaft and the output shaft can be easily shortened. As a result, it is possible to position the motor shaft close to the output shaft to which the end tool is mounted, making it possible to position the center of gravity of the electric motor close to the output shaft. Thus, the rotating end tool can be easily applied to a working object, making it possible to improve the operability of the electric tool.

Here, if the rotational axis of the motor shaft coincides with the vertical direction, the center of gravity with respect to the horizontal direction of the electric motor is located on the line in which the rotational axis of the motor shaft extends. Here, the “same direction” described above is a direction which is set so as to “be capable of making it easier for the distance between the motor shaft and the output shaft to be shortened”, and it may be a direction which is set such that an angle crossing to each other of them is, for example, 5 to 10 degrees.

The electric motor may be an outer rotor type motor or may be a brushless motor.

A plurality of battery attachment portions may be provided in a side-by-side arrangement, and each of the plurality of the battery attachment portions may be configured such that the rechargeable battery is attached by through sliding in a direction parallel to the direction in which the motor shaft extends.

A handle portion may be disposed between the electric motor and the battery attachment portion, and a vibration isolation rubber may be provided between a housing for supporting the electric motor and a handle housing for setting the handle portion.

One side of each of the motor shaft and the output shaft may be supported by a motor housing via a bearing, and the other side of each of them may be supported by a gear housing via a bearing.

In another aspect according to the present disclosure, an electric tool may comprise a battery attachment portion to which a rechargeable battery is attached through sliding, an electric motor rotationally driving a motor shaft by electric power from the rechargeable battery, and a handle portion configured to be capable of an operation for rotationally driving the electric motor. The electric motor may be set at a position closer to an output shaft to which an end tool is mounted, than the battery attachment portion. The battery attachment portion may be set at a position closer to the output shaft to which the end tool is mounted, than the handle portion.

The electric motor may be set at a position closer to the output shaft than the battery attachment portion, so that it is possible to position the center of gravity of the electric motor closer to the output shaft than the center of gravity of the rechargeable battery attached to the battery attachment portion. Further, the battery attachment portion may beset at a position closer to the output shaft than the handle portion, so that it is possible to position the center of gravity of the rechargeable battery attached to the battery attachment portion, closer to the output shaft than the handle portion.

As a result, it is possible to position the center of gravity of the electric motor and the center of gravity of the rechargeable battery close to the output shaft in that order. Thus, it is possible to position the center of gravity of the tool close to the working position of the rotating end tool, and to make it easier for the rotating end tool to be applied to the working object, thus making it possible to improve the tool operability.

A plurality of the battery attachment portions may be provided in a side-by-side arrangement, and each of the plurality of battery attachment portions may be configured such that the rechargeable battery is attached through sliding in a direction perpendicular to a direction in which the motor shaft extends.

Each of the plurality of battery attachment portion may be configured such that the rechargeable battery is attached through sliding in a direction perpendicular to a direction in which the handle portion extends.

The handle portion may be provided with an operation switch, and the operation switch may be a trigger type switch configured to allow a pulling operation while the handle portion is grasped.

### BRIEF DESCRIPTION OF THE DRAWINGS

FIG. 1 is a perspective view of a disc grinder according to a first embodiment.

FIG. 2 is an internal-structure sectional view taken along arrow line (II)-(II) in FIG. 1.

FIG. 3 is an internal-structure sectional view taken along arrow line (III)-(III) in FIG. 1.

FIG. 4 is an internal-structure sectional view illustrating a modification of the structure of FIG. 2.

FIG. 5 is an internal-structure sectional view illustrating a modification of the structure of FIG. 3.

FIG. 6 is a perspective view of a disc grinder according to a third embodiment.

FIG. 7 is an internal-structure sectional view taken along arrow line (VII)-(VII) in FIG. 6.

FIG. 8 is an internal-structure sectional view taken along arrow line (VIII)-(VIII) in FIG. 6.

FIG. 9 is a perspective view of a disc grinder according to a fourth embodiment.

FIG. 10 is an internal-structure sectional view taken along arrow line (X)-(X) in FIG. 9.

FIG. 11 is an internal-structure sectional view taken along arrow line (XI)-(XI) in FIG. 9.

### DETAILED DESCRIPTION

### First Embodiment

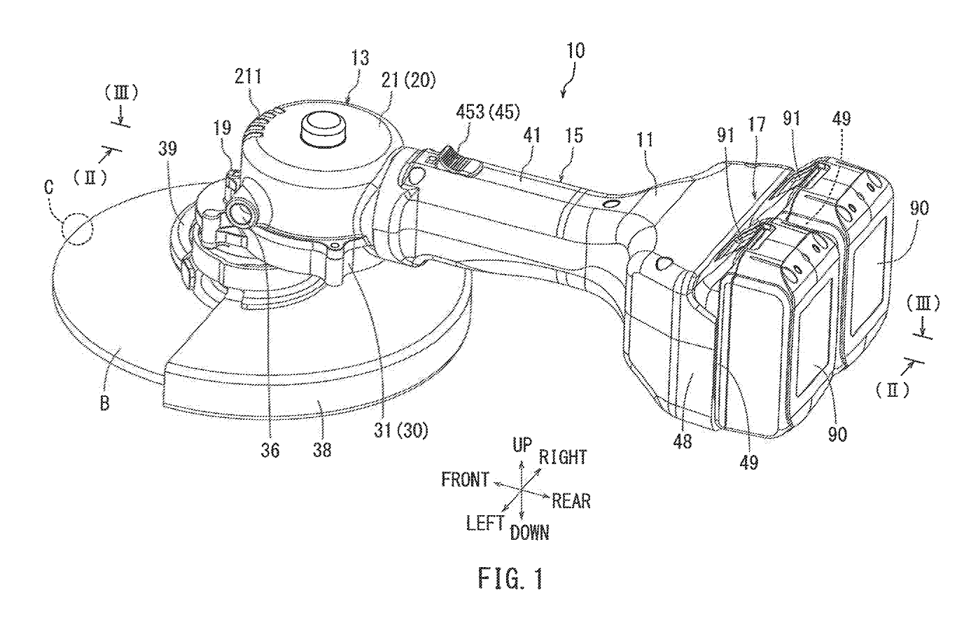

Next, a disc grinder according to a first embodiment configured as an electric tool will be described with reference to FIGS. 1 through 3. FIGS. 1 through 3 show a disc grinder 10, which is a hand-held type disc grinder that is held by a hand(s) of the user for performing a working operation.

In describing this disc grinder 10, the directions as given in the drawings will be referred to. The disc grinder 10 generally includes a tool main body 11 and two rechargeable batteries 90. As shown in FIGS. 1 through 3, the tool main body 11 includes, as from the front side, a drive portion 13, a handle portion 15, and a battery attachment portion 17.

The drive portion 13 includes a motor portion 20 and a gear portion 30. The motor portion 20 has a motor housing 21 accommodating an outer-rotor type brushless DC motor 22. The motor housing 21 is formed in a shape of a cup made of metal, which accommodates the brushless DC motor 22. More specifically, the motor housing 21 is molded from aluminum as a material. The motor housing 21 supports the brushless DC motor 22, and is connected to a gear housing 31 and a handle housing 41. The brushless DC motor 22 corresponds to an electric motor according to the present disclosure. The brushless DC motor 22 rotationally drives a motor shaft 25 by electric power supplied from the rechargeable batteries 90.

The motor shaft 25 is rotatably supported by an upper bearing 241 and a lower bearing 242. The upper bearing 241 and the lower bearing 242 are formed by ball bearings. The motor housing 21 supports the upper bearing 241 of the motor shaft 25 and an upper bearing 341 of an output shaft 35 that will be described later. On the other hand, a gear housing 31 that will be described later supports the lower bearing 242 of the motor shaft 25 and a lower bearing 342 of the output shaft 35.

The brushless DC motor 22 generally includes a stator 26 supported by the motor housing 21, and an outer rotor 27 supported by the motor shaft 25. The stator 26 has a stator core 261 and a stator coil 262. The stator core 261 is supported by the motor housing 21. The stator coil 262 is formed by coils to which electric power is supplied to generate a magnetic field, and is supported by the stator core 261. The outer rotor 27 is arranged on the outer circumferential side of the stator 26, and is integrated with the motor shaft 25 at a position on the upper side of the stator core 261.

On the lower side of the outer rotor 27, there is provided a sensor board 28 that detects the rotational position of the outer rotor 27. A cooling fan 29 is mounted to the upper portion of the motor shaft 25. The cooling fan 29 rotates together with the motor shaft 25, whereby air is drawn from the lower side where the stator 26 is arranged, and is discharged in the centrifugal direction with respect to the motor shaft 25. The discharge air from the cooling fan 29 is discharged to the outside from discharge openings 211 provided in the motor housing 21.

The gear portion 30 is constituted by the gear housing 31 with a reduction gear unit 32 accommodated therein. The gear housing 31 is connected to the motor housing 21 on the lower side of the motor housing 21 via screw members 19. While accommodating the reduction gear unit 32, the gear housing 31 supports the lower bearing 242 of the motor shaft 25 and the lower bearing 342 of the output shaft 35. The reduction gear unit 32 includes a motor gear 331 and a reduction gear 332 that are spur gears in mesh with each other. The reduction gear unit 32 reduces the rotation of the motor shaft 25, which is 12,000 RPM, to 6,000 to 8,000 RPM. The motor gear 331 is integrally mounted to the motor shaft 25 so that it may rotate together with the motor shaft 25.

The reduction gear 332 is integrally mounted to the output shaft 35 so that it may rotate together with the output shaft 35. As compared with the motor gear 331, the reduction gear 332 is of a larger diameter and has a greater number of teeth. Thus, the rotational drive of the motor gear 331 is reduced in speed and transmitted to the reduction gear 332. That is, the reduction gear 332 is in mesh with the motor gear 331, reduces in speed the rotational drive of the motor shaft 25 and transmits the rotational drive to the output shaft 35. The output shaft 35 to which the rotational drive is transmitted provides a rotational output to cause rotation of a circular grinding wheel B mounted to the output shaft 35.

The output shaft 35 is rotatably supported by the upper bearing 341 and the lower bearing 342. The upper bearing 341 and the lower bearing 342 are constituted by ball bearings. The gear housing 31 supports the lower bearing 242 of the motor shaft 25 and the lower bearing 342 of the output shaft 35. The circular grinding wheel B as the end tool is mounted to the lower end of the output shaft 35. This grinding wheel B is mounted to the output shaft 35 via a clamp mechanism 37. The grinding wheel B rotates together with the output shaft 35. This grinding wheel B grinds the grinding object as a front side portion C is pressed against the grinding object. A rotational axis X of the motor shaft 25 coincides with the up-down direction, which is the vertical direction, so that the center of gravity with respect to the horizontal direction of the brushless DC motor 22 is located on the line of the rotational axis X of the motor shaft 25.

Here, both the motor gear 331 and the reduction gear 332 are configured as spur gears and are in mesh with each other. That is, in the motor gear 331, the teeth are cut in parallel to the motor shaft 25, and, in the reduction gear 332, the teeth are cut in parallel to the output shaft 35. Thus, in the state in which the motor gear 331 and the reduction gear 332 are in mesh with each other, the motor shaft 25 and the output shaft 35 constituting their respective rotation shafts are arranged so as to extend in the up-to-down direction and parallel to each other.

The arrangement of the brushless DC motor 22 and the reduction gear unit 32 is set such that the rotational axis X of the motor shaft 25 and a rotational axis Y of the output shaft 35 are arranged parallel to each other. That is, the arrangement relationship between the brushless DC motor 22 and the reduction gear 332 is set such that the rotational axis Y of the output shaft 35 extends in the same direction as the extending direction of the rotational axis X of the motor shaft 25. Further, the brushless DC motor 22 is set at a position closer to the output shaft 35 to which the grinding wheel B is mounted than the battery attachment portion 17 and the handle portion 15.

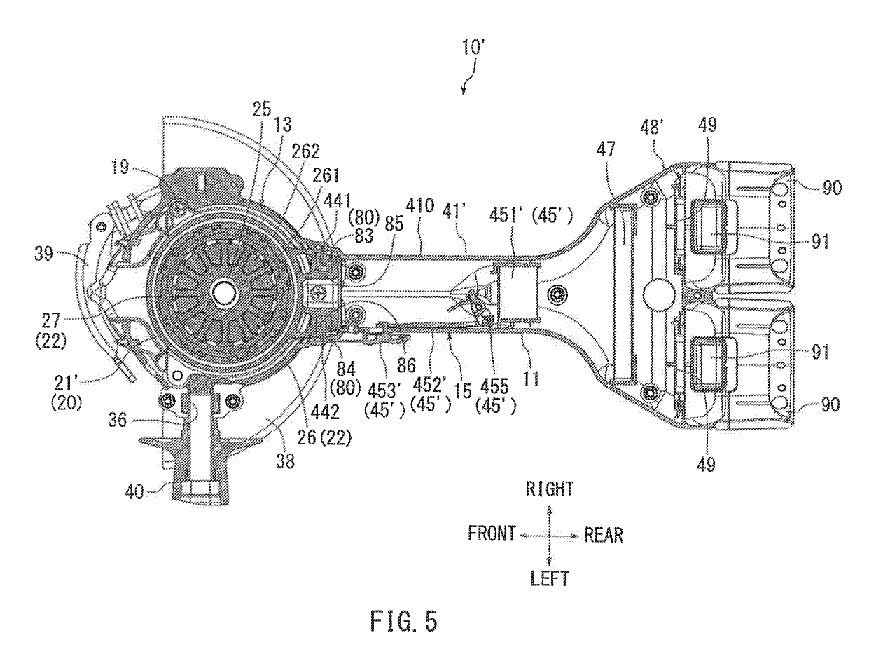

Reference numeral 38 denotes a wheel cover that inhibits scattering of dust generated from the working object. The wheel cover 38 is mounted to the gear housing 31 via a clamp mechanism 39. Although not shown in the drawings, the gear housing 31 is provided with a shaft lock mechanism used for replacement of the grinding wheel B. At the gear housing 31, the shaft lock mechanism relatively locks the rotation of the reduction gear 332, making it possible to perform a loosening operation and a tightening operation of the clamp mechanism 37 that clamps the grinding wheel B. Further, on both right and left sides of the motor housing 21, there are provided sub grip attachment portions 36 allowing the attachment of a sub grip (reference numeral 40 in, for example, FIG. 5). That is, this disc grinder 10 is configured as a so-called two-handle type disc grinder.

The arrangement relationship between the brushless DC motor 22 and the reduction gear unit 32 is set such that they are arranged relative to each other in the up and down relationship. That is, the reduction gear unit 32 is arranged at a position on the upper side of the output shaft 35. Further, the brushless DC motor 22 is arranged at a position on the upper side of the reduction gear unit 32. However, the motor gear 331 and the reduction gear 332 are in mesh with each other in the front-rear direction. Thus, the motor shaft 25 which is the rotation shaft of the motor gear 331 and the output shaft 35 which is the rotation shaft of the reduction gear 332 are displaced from each other in the rear and front relationship. That is, the brushless DC motor 22 and the reduction gear unit 32 are arranged so as to be displaced from each other in the rear and front relationship.

The handle portion 15 is connected to the rear side of the drive portion 13. The handle portion 15 includes the handle housing 41. The handle housing 41 has a substantially tubular extending in the front-rear direction. The handle housing 41 is formed by joining together half resin members molded as tube halves. The handle portion 15 is provided with an operation switch 45 allowing the operation of the rotational drive of the brushless DC motor 22. The operation switch 45 includes a switch main body 451, a slide body 452, and an operation knob 453. The switch main body 451 is configured as a contact switch having an on-input ability.

The slide body 452 is set so as to be capable of the on-input to the switch main body 451 in response to the forward sliding movement of the operation knob 453. Further, the operation knob 453 is arranged on the outer side of the upper surface of the handle housing 41. That is, this operation switch 45 is set so as to allow the user to perform the switch operation on the upper side of the tool main body 11. In the interior of the handle housing 41 set as the handle portion 15, there is solely installed the structure related to the operation switch 45.

At the rear portion of the handle portion 15, there is provided the battery attachment portion 17 for the attachment of the rechargeable batteries 90. The rear portion of the handle portion 15 is the rear portion of the tool main body 11. The battery attachment portion 17 is set such that two slide-mount type rechargeable batteries 90 can be attached in a side-by-side relationship. That is, at the rear portion of the handle housing 41, there is provided a width enlargement portion 48 enlarged in width in the right-width direction. At the rear surface of the width enlargement portion 48, there are provided two slide attachment portions 49 arranged side-by-side in the left-to-right direction.

Inside the width enlargement portion 48 on which the battery attachment portion 27 is provided, there is provided a controller 47 for supplying electric power to the brushless DC motor 22 from the attached rechargeable batteries 90. The controller 47 is constituted to be equipped with various electrical components such as a shunt resistor and, for example, six FET (field-effect transistor) circuits, and controls the voltage, etc. of the electric power supplied from the rechargeable batteries 90. Air intake opening(s) (not shown) is provided in the handle housing 41 at a position on the lower side of the controller 47. That is, due to the discharge air (intake air) of the aforementioned cooling fan 29, external air is drawn into the handle housing 41 via the intake opening(s). The drawn external air cools the controller 47 and also cools the stator 26 (stator coil 262).

Each of the two slide attachment portions 49 is configured such that the rechargeable battery 90 is attached as the rechargeable battery 90 is slid downwards from above. Conversely, by sliding the rechargeable battery 90 upwards from below while a lock off button 91 of the rechargeable battery 90 being depressed, it is possible to detach the rechargeable battery 90 from the slide attachment portion 49. The two rechargeable batteries 90 attached to the two slide attachment portions 49 function as the power source of the disc grinder 10. The two rechargeable batteries 90 are configured as slide-mount type rechargeable batteries, the supply power voltage of which is set to 18 V.

With the disc grinder 10 of the first embodiment described above, the rotational axis X of the motor shaft 25 and the rotational axis Y of the output shaft 35 are set to be parallel to each other, so that the distance between the motor shaft 25 and the output shaft 35 can be easily shortened. As a result, it is possible to position the motor shaft 25 close to the output shaft 35 to which the grinding wheel B is mounted, making it possible to position the center of gravity of the brushless DC motor 22 close to the output shaft 35. Thus, the front side portion C of the rotating grinding wheel B can be easily applied to the grinding object, making it possible to enhance the tool operability of the disc grinder 10. Further, with the disc grinder 10 of the first embodiment described above, the motor gear 331 and the reduction gear 332 are constituted by spur gears in mesh with each other for effecting drive transmission to the output shaft 35. As a result, it is possible to constitute the reduction gear unit 32 at a lower cost, and to achieve an improvement in terms of the durability of the reduction gear unit 32.

Further, with the disc grinder 10 of the first embodiment described above, the rechargeable batteries 90 are attached through sliding downwards from above at the rear portion of the tool main body 11. Further, the controller 47 is accommodated in the width enlargement portion 48 on which the battery attachment portion 17 is provided. Here, the handle portion 15 is set on the front side of the portion where the battery attachment portion 17 and the controller 47 are arranged. As a result, it is possible to shorten the front-rear length of the disc grinder 10, making it possible to enhance the tool operability.

Further, with the disc grinder 10, the motor portion 20 and the gear portion 30 are arranged at the front portion, and the rechargeable batteries 90 and the controller 47 are arranged at the rear portion. Thus, with the disc grinder 10, when the user holds the handle portion 15 arranged at the intermediate position in the front-rear direction of the disc grinder 10, a front-to-rear balance in weight can be achieved as if it were an iron dumbbell. As a result, it is possible to configure the disc grinder 10 to be front-to-rear balanced in weight and which is enhanced in tool operability.

The handle portion 15 may have a simple construction without including the battery attachment portion 17 and the controller 47. That is, the outer configuration of the handle portion 15 can be set to a configuration which can be easily grasped by the user by forming it, for example, simply thinner. Thus, with the disc grinder 10 of the first embodiment described above, the grip is easier to grasp for the user, thus making it possible to enhance the tool operability.

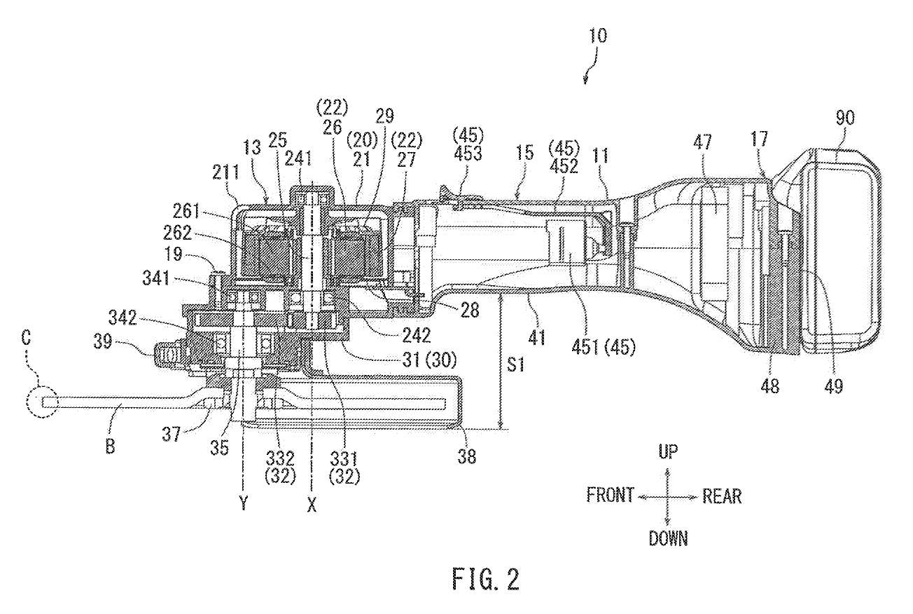

Similarly, the rechargeable batteries 90 and the controller 47 are arranged at the rear portion of the tool main body 11, and the motor shaft 25 is arranged vertically near the output shaft 35, so that the hand-grasping position of the user can be positioned to be closer to the output shaft 35. As a result, the hand-grasping position of the user is positioned close to the front side portion C of the grinding wheel B, and it is possible to improve the operation accuracy of the front side portion C, making it possible to improve the tool operability during the grinding operation. Furthermore, with the disc grinder 10 of the first embodiment described above, the handle portion 15 is reduced in bulkiness, so that the handle portion 15 is set to be vertically spaced away from the lower end of the disc grinder 10 by a distance S1 as shown in FIG. 2. As a result, an angle can be easily given between the front side portion C of the grinding wheel B and the hand-grasping position of the user, making it possible to improve the tool operability during the grinding operation.

Further, with the disc grinder 10 of the first embodiment described above, the motor portion 20 and the gear portion 30 are put together in the drive portion 13, whereby it is possible to reduce the number of components installed inside the handle portion 15. More specifically, within the handle housing 41, the brushless DC motor 22, which has conventionally been installed, is eliminated, and solely the operation switch 45 is installed.

As a result, it is possible to downsize the handle housing 41, and to reduce the outer circumferential diameter of the handle portion 15. Thus, the handle portion 15 can be made thinner and easier to grasp for the user, making it possible to constitute the disc grinder 10 to be improved in operability. Further, with this disc grinder 10, the number of components installed inside the handle portion 15 is reduced, so that it is possible to incorporate a vibration isolating structure 80 as in a second embodiment described below.

### Second Embodiment

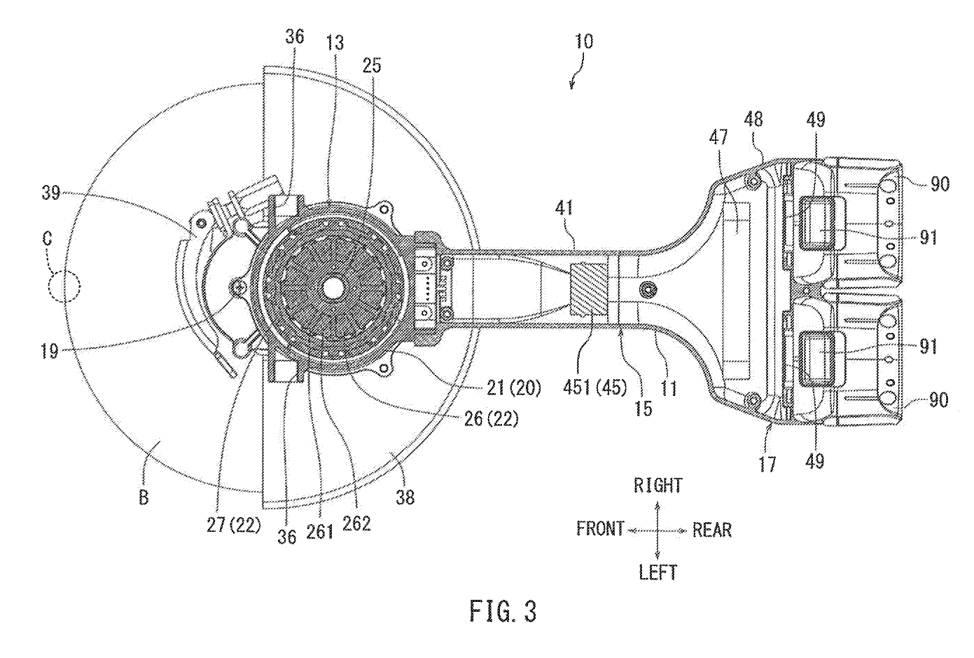

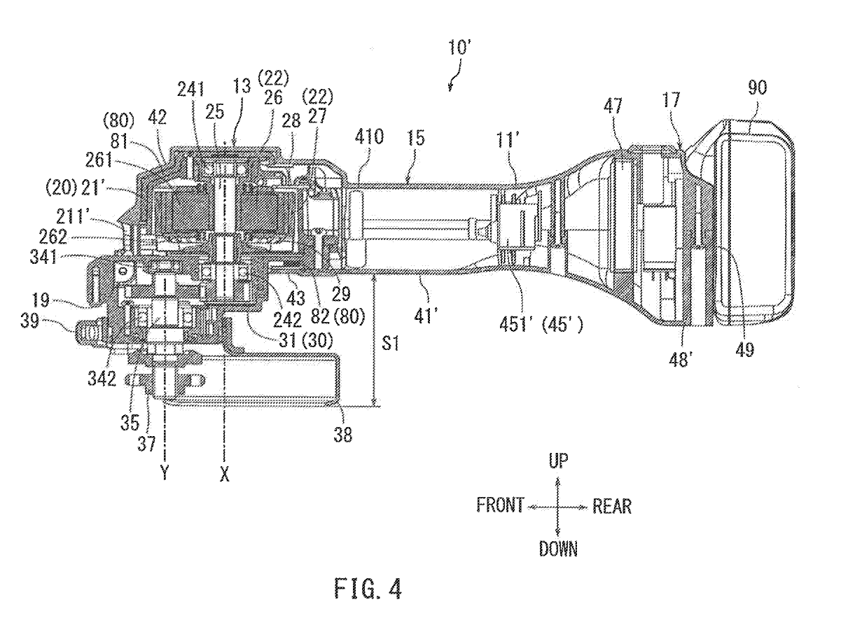

Next, a disc grinder 10′ according to the second embodiment, which is a modification of the disc grinder 10 of the first embodiment described above, will be described. Internal-structure sectional views in FIGS. 4 and 5 illustrate the disc grinder 10′, which is a modification of the disc grinder shown in FIGS. 2 and 3. In brief, as compared with the disc grinder 10 of the first embodiment described above, the disc grinder 10′ of the second embodiment differs in the structure relating a handle housing 41′, and in other respect, the disc grinder 10′ is configured to be similar to the disc grinder 10 of the first embodiment described above.

Thus, for the disc grinder 10′, portions which are of the similar construction as those of the disc grinder 10 of the first embodiment described above are labeled with the same reference numerals, and a description thereof will be left out. Further, for the disc grinder 10′, portions which are of the same function as those of the disc grinder 10 of the first embodiment described above are labeled with the same reference numerals with the sign “′” affixed at their ends.

A tool main body 11′ of the second embodiment has a handle housing 41′ which is different from the handle housing 41 of the first embodiment described above. That is, the handle housing 41′ of the second embodiment is molded to have a configuration covering a motor housing 21′. More specifically, as compared with the handle housing 41 of the first embodiment, the handle housing 41′ is provided with an extension upper side portion 42 and an extension lower side portion 43 each extending forwards from a housing main body 410.

The extension upper side portion 42 and the extension lower side portion 43 are shaped to correspond to the outer circumferential configuration of the motor housing 21′. More specifically, the extension upper side portion 42 is shaped in conformity with the upper surface configuration of the motor housing 21′ so as to cover the motor housing 21′ from above. Similarly, the extension lower side portion 43 is shaped in conformity with the lower surface configuration of the motor housing 21′ so as to cover the motor housing 21′ from below.

Further, the handle housing 41′ is of a configuration covering the front surface and both right and left side surfaces of the motor housing 21′, and is shaped so as to be continuous with the extension upper side portion 42 and the extension lower side portion 43. In the front surface of this handle housing 41′, there is provided discharge openings 211′ for discharging the discharge air from the cooling fan 29 to the outside. The cooling fan 29 is mounted to the lower portion of the motor shaft 25. The sensor board 28 detecting the rotational position of the outer rotor 27 is disposed on the upper side of the outer rotor 27.

An operation switch 45′ provided on the handle housing 41′ is set such that the user can perform the switching operation on the left side of the tool main body 11. That is, the operation switch 45′ includes a switch main body 451′, a slide body 452′, an operation knob 453′, and a rotary input member 455. The operation knob 453′ of the second embodiment is arranged on the outer side of the left side surface of the handle housing 41′. The rotary input member 455 is rotated by the sliding movement of the slide body 452, and, the rotary input member 455 is configured to effect an on-input to the switch main body 451 through this rotation.

The switch main body 451′ and the slide body 452′ are configured to be similar to those of the first embodiment described above. Inside the handle housing 41′ set as the handle portion 15, solely the structure related to the operation switch 45′ is installed. Further, also at the rear portion of the handle housing 41′, there is provided a width enlargement portion 48′ on which the battery attachment portion 17 is provided. The width enlargement portion 48′ is enlarged in width more smoothly in the right-left direction than the width enlargement portion 48 of the first embodiment described above.

Incidentally, the tool main body 11′ is provided with the vibration isolating structure 80 for reducing the vibrations transmitted to the handle portion 15 that is grasped by the hand(s). The vibration isolating structure 80 is formed by providing vibration isolating rubbers 81, 82, 83, and 84 between the motor housing 21′ and the handle housing 41′. The vibration isolating rubbers 81, 82, 83, and 84 are formed by rubber sheets or elastic resin sheets of the same material. More specifically, as shown in FIG. 4, an upper vibration isolating rubber 81 is provided between the upper surface of the motor housing 21′ and the extension upper side portion 42 of the handle housing 41′.

Further, also between the lower surface of the motor housing 21′ and the extension lower side portion 43, there is provided a lower vibration isolating rubber 82. The upper vibration isolating rubber 81 and the lower vibration isolating rubber 82 are provided between the outer circumferential configuration of the motor housing 21′ and the configuration of the handle housing 41′ molded in conformity with the outer circumferential configuration of the motor housing 21′ so as to be held therebetween. The upper vibration isolating rubber 81 and the lower vibration isolating rubber 82 are provided between the motor housing 21′ and the handle housing 41′ so as to be pressed between them.

Further, as shown in FIG. 5, at the rear portion of the motor housing 21′, there are provided between the rear portion and the handle housing 41′ a right side vibration isolating rubber 83 and a left side vibration isolating rubber 84. The portion where the right side vibration isolating rubber 83 and the left side vibration isolating rubber 84 are provided is configured to be symmetrical with respect to the center axis along which the handle housing 41′ extends.

At the rear portion of the motor housing 21′, a right side concave portion 85 and a left side concave portion 86 are provided integrally with the motor housing 21′, and, on the inner circumferential surface of the handle housing 41′ facing the right side concave portion 85 and the left side concave portion 86, there are provided a right side convex portion 441 and a left side convex portion 442 so as to be integral with the handle housing 41′. The right side concave portion 85 is formed to have a configuration concaved to the right side, and the right side convex portion 441 is formed to have a rib shape protruding into the right side concave portion 85. The left side concave portion 86 is formed to have a configuration concaved to the left side, and the left side convex portion 442 is formed to have a rib shape protruding into the left side concave portion 86.

Here, the right side vibration isolating rubber 83 is provided between the right side concave portion 85 and the right side convex portion 441, and the left side vibration isolating rubber 84 is provided between the left side concave portion 86 and the left side convex portion 442. The right side vibration isolating rubber 83 is provided between the right side concave portion 85 and the right side convex portion 441 so as to be pressed between them while in close contact with both of them. The left side vibration isolating rubber 84 is provided between the left side concave portion 86 and the left side convex portion 442 so as to be pressed between them while in close contact with both of them. Due to the provision of the vibration isolating rubbers 81, 82, 83, and 84 in this way, in transmitting the vibrations generated in the drive portion 13 to the handle portion 15, the vibrations are reduced before transmission from the drive portion 13 to the handle portion 15.

### Third Embodiment

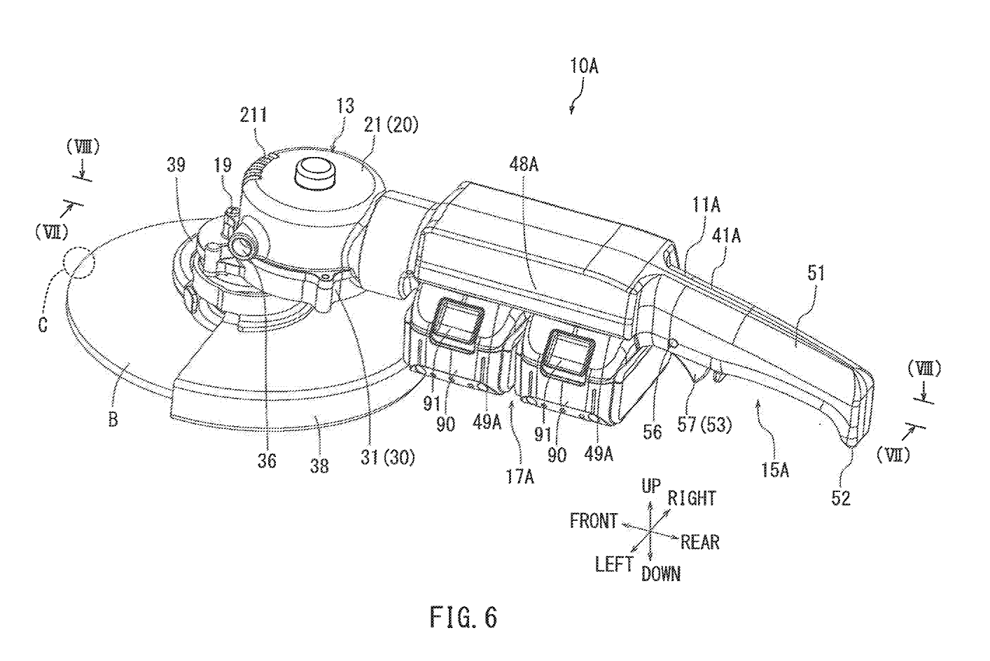

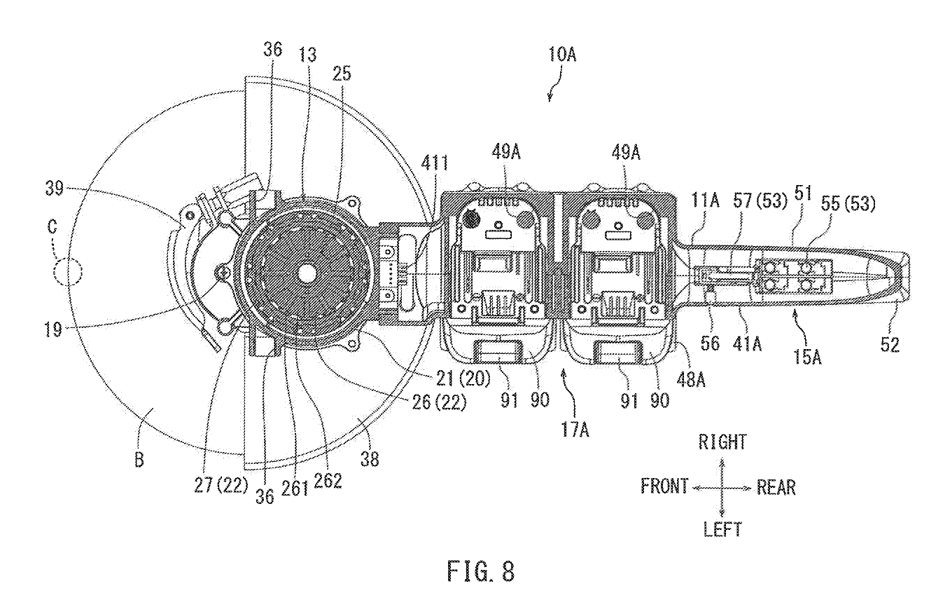

Next, a disc grinder according to a third embodiment will be described with reference to FIGS. 6 through 8. FIG. 6 is a perspective view of a disc grinder 10A according to the third embodiment. As compared with the disc grinder 10 of the first embodiment, the disc grinder 10A of the third embodiment differs in that the arrangement position of the handle portion 15 and the arrangement position of the battery attachment portion 17 are alternated.

Thus, in describing the disc grinder 10 of the third embodiment, portions of the same construction as those of the disc grinder 10 of the first embodiment are labeled with the same reference numerals as used for the description of the first embodiment, and a description thereof will be left out. Further, in describing the disc grinder 10 of the third embodiment, portions similar to those of the disc grinder 10 of the first embodiment are labeled with the same reference numerals used for the description of the first embodiment, with the sign “A” affixed to their ends.

That is, regarding the drive portion 13, the disc grinder 10A of the third embodiment is of the same construction as the disc grinder 10 of the first embodiment. In the disc grinder 10A of the third embodiment, a battery attachment portion 17A is disposed on the rear side of the drive portion 13, and a handle portion 15A is disposed on the rear side of the battery attachment portion 17A. Both the battery attachment portion 17A and the handle portion 15A are formed by a handle housing 41A. That is, the battery attachment portion 17A is disposed at the lower surface of the front portion of the handle housing 41A, and the handle portion 15A is disposed at the rear portion of the handle housing 41A.

As in the first embodiment described above, also in the battery attachment portion 17A of the third embodiment, setting is made such that the two rechargeable slide-mount type batteries 90 can be attached side-by-side by sliding. That is, on the lower surface of the front portion of the handle housing 41, there is provided a width enlargement portion 48A enlarged in width in the right-left direction. On the lower surface of the width enlargement portion 48, there are provided two slide attachment portions 49A arranged side-by-side in the front-rear direction.

Each of the two slide attachment portions 49 is configured such that the rechargeable battery 90 can be attached through sliding the rechargeable battery 90 from the left to the right side. Conversely, as the rechargeable battery 90 is slide from the right to the left side while the lock off button 91 of the rechargeable battery 90 being depressed, the rechargeable battery 90 can be detached from the slide attachment portion 49. Like the rechargeable batteries 90 of the first embodiment described above, the two rechargeable batteries 90 attached to the two slide attachment portions 49A are slide-mount type rechargeable batteries, the supply electric power voltage of which is set to 18 V.

The handle portion 15A is disposed on the rear side of the two slide attachment portions 49A. The handle portion 15A is constituted by the rear portion of the handle housing 41A. That is, the handle portion 15A is disposed at the rearmost portion of the tool main body 11. The handle portion 15A extends backwards from the battery attachment portion 17A so as to have a grip shape that can be grasped by hand. More specifically, the handle portion 15A extends by a columnar portion 51 that can be grasped by hand in a manner like a bat grip. At the rear end of the columnar portion 51, there is provided a grip end portion 52 protruding downward. The grip end portion 52 serves to inhibit removal of the hand grasping the columnar portion 51.

On the front side of the columnar portion 51, there is provided an operation switch 53. The operation switch 53 is a switch enabling the operation for rotationally driving the brushless DC motor 22. The arrangement position and the operational structure of the operation switch 53 are such that pulling operation is possible with the index finger or the middle finger of the hand grasping the columnar portion 51. The operation switch 53 includes a switch main body 55 and an operation trigger 57.

The switch main body 55 is configured by a contact switch having an on-input ability. The operation trigger 57 is provided with a lock off button 56. Thus, when the lock off button 56 is depressed with the thumb of the hand grasping the columnar portion 51, and the operation trigger 57 is pulled with the index finger or the middle finger, the operation trigger 57 is pivoted through pulling. When rotated through pulling, the operation trigger 57 effects an on- to the switch main body 55.

Similar to the disc grinder 10 of the first embodiment described above, also in the disc grinder 10A of the third embodiment, the arrangement of the brushless DC motor 22 and the reduction gear unit 32 is set such that the rotational axis X of the motor shaft 25 and the rotational axis Y of the output shaft 35 are arranged parallel to each other. Further, the brushless DC motor 22 is set at a position closer to the output shaft 35, to which the grinding wheel B is mounted, than the battery attachment portion 17A and the handle portion 15A.

With the disc grinder 10A of the third embodiment, the brushless DC motor 22 is set at a position closer to the output shaft 35 than the battery attachment portion 17A, so that it is possible to position the center of gravity of the brushless DC motor 22 closer to the output shaft 35 than the center of gravity of the rechargeable batteries 90 attached to the battery attachment portion 17A. Further, in the disc grinder 10A of the third embodiment, the handle portion 15A is set at the rear portion of the tool main body 11, so that, when a sub grip (not shown) is mounted to the sub grip attachment portion 36, it is possible to provide a large distance between the handle portion 15A and the sub grip, thus allowing the disc grinder to be held in the manner as in the known art.

In addition, the two rechargeable batteries 90 are arranged between the handle portion 15A and the sub grip, so that it is easy to achieve a balance in weight when the user holds the disc grinder with both hands. Further, the motor shaft 25 is arranged vertically near the output shaft 35, so that the front portion of the tool main body 11 is configured to be compact. Due to this arrangement, it is possible to finely adjust the position of the front side portion C of the grinding wheel B to further improve the tool operability while providing a two-handle feel of use as in the known art.

Further, also regarding the battery attachment portion 17A, it is set at a position closer to the output shaft 35 than the handle portion 15A, so that it is possible to position the center of gravity of the rechargeable batteries 90 attached to the battery attachment portion 17A closer to the output shaft 35 than the handle portion 15A. As a result, it is possible to position the center of gravity of the brushless DC motor 22 and the center of gravity of the rechargeable batteries 90 close to the output shaft 35 in that order. Thus, it is possible to position the center of gravity of the tool close to the grinding position of the rotating grinding wheel B, and to make it easier to apply the front side portion C of the rotating grinding wheel B to the grinding object, making it possible to improve the tool operability.

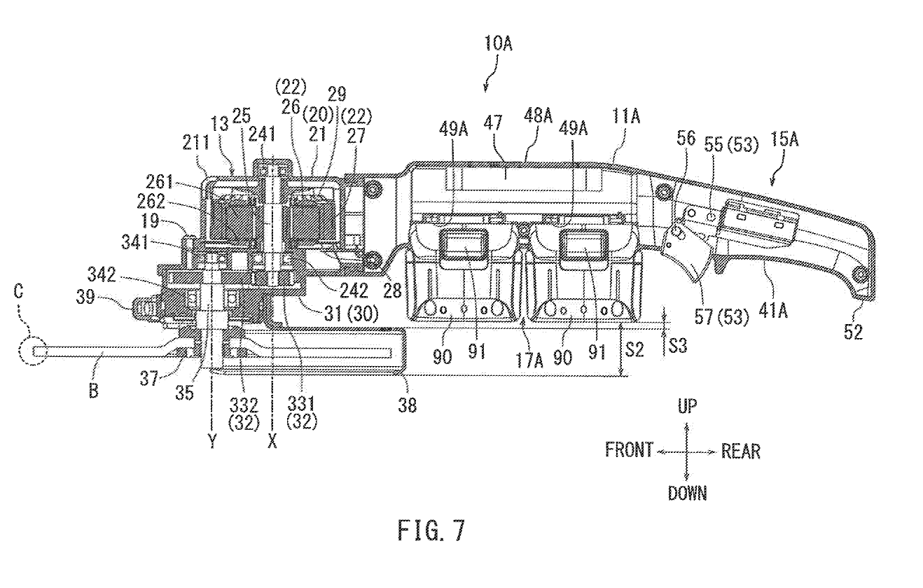

Further, with the disc grinder 10A of the third embodiment described above, there is a distance S2 shown in FIG. 7 between the lower ends of the attached rechargeable batteries 90 and the lower end of the disc grinder 10. As a result, the position in the vertical direction of the handle portion 15A set at the rear portion of the tool main body 11 can be easily changed, making it possible to improve the operability of the tool during the grinding operation. Further, there is a distance S3 shown in FIG. 3 between the lower ends of the rechargeable batteries 90 and the upper end of the wheel cover 38, so that the operation of attaching/detaching the rechargeable batteries 90 can be easily performed.

### Fourth Embodiment

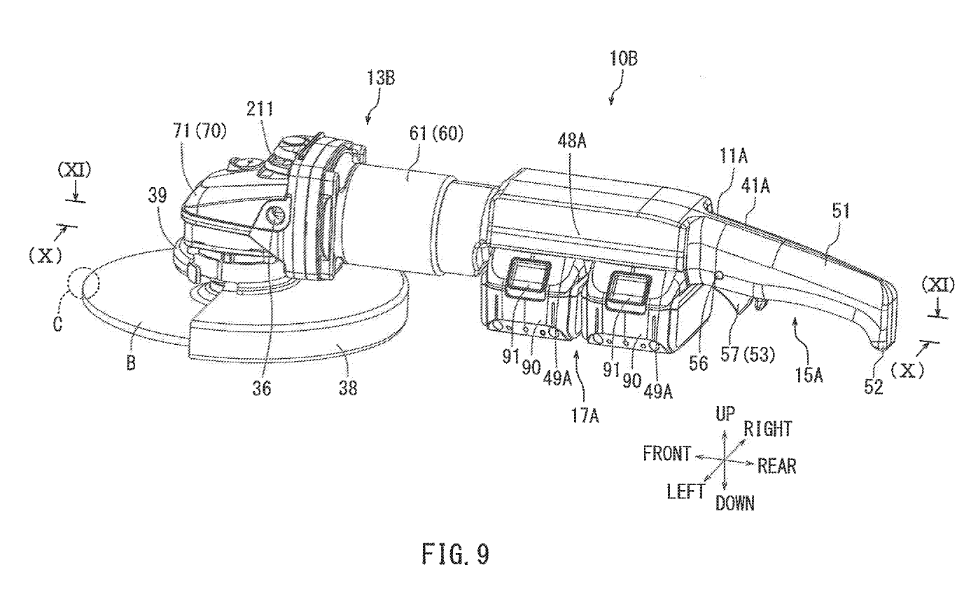

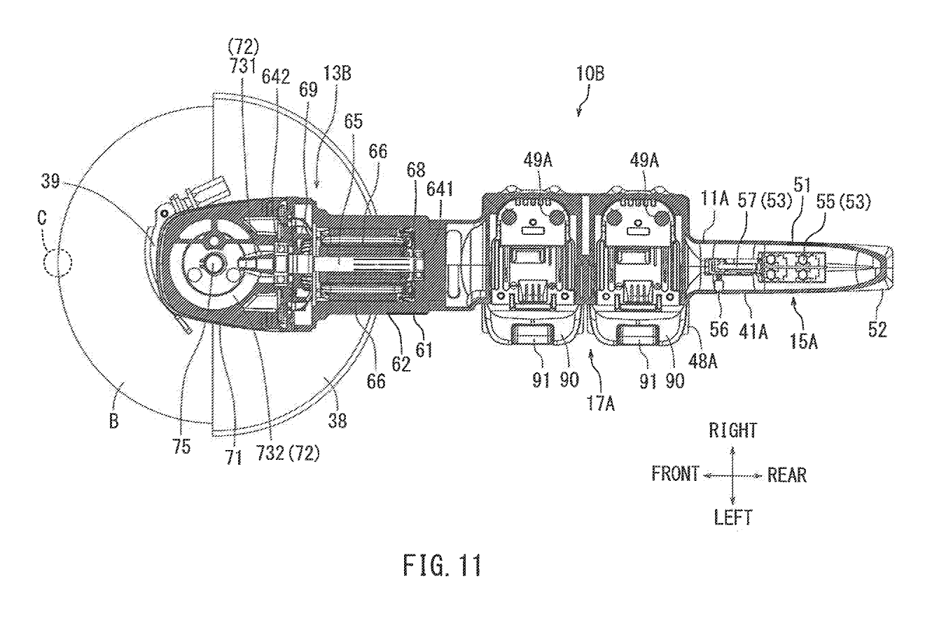

Next, a disc grinder according to a fourth embodiment will be described with reference to FIGS. 9 through 11. FIG. 9 is a perspective view of a disc grinder 10B according to the fourth embodiment. The disc grinder 10B according to the fourth embodiment is a modification of the disc grinder 10A according to the third embodiment.

As compared with the disc grinder 10A of the third embodiment, the disc grinder 10B of the fourth embodiment differs in the construction of the drive portion 13B. Thus, in describing the disc grinder 10B of the fourth embodiment, portions of the same construction as those of the disc grinder 10A of the third embodiment are labeled with the same reference numerals as used in the description of the third embodiment, and a description thereof will be left out.

Also, the drive portion 13B of the fourth embodiment includes a motor portion 60 and a gear portion 70. The motor portion 60 is constituted by a motor housing 61 with an inner rotor type brushless DC motor 62 accommodated therein. The motor housing 61 is formed by a metal tube accommodating the brushless DC motor 22 therein. The motor housing 61 supports the brushless DC motor 62, and is connected to a gear housing 71 and a handle housing 41A. The brushless DC motor 62 corresponds to and electric motor according to the present disclosure. The brushless DC motor 62 rotates a motor shaft 65 by electric power supplied from the rechargeable batteries 90.

The motor shaft 65 is rotatably supported by a rear side bearing 641 and a front side bearing 642. The rear side bearing 641 and the front side bearing 642 are formed by ball bearings. The rear side bearing 641 is supported by the motor housing 61, and the front side bearing 642 is supported by the gear housing 71. The brushless DC motor 62 generally includes a stator 66 supported by the motor housing 61, and an inner rotor 67 supported by the motor shaft 65.

The inner rotor 67 is arranged on the inner circumferential side of the stator 66. On the rear side of the inner rotor 67, there is provided a sensor board 68 for detecting the rotational position of the inner rotor 67. A cooling fan 69 is mounted to the front portion of the motor shaft 65. The cooling fan 69 rotates together with the motor shaft 65 to thereby cool the stator 66, and the cooling air is discharged to the outside from discharge openings 211 provided in the gear housing 71.

The gear housing 70 is constituted by the gear housing 71 with a reduction gear unit 72 accommodated therein. On the front side of the motor housing 61, the gear housing 71 is connected to the motor housing 61 via the screw members 19. The gear housing 71 supports the front side bearing 642 of the motor shaft 65 while accommodating the reduction gear unit 72. Further, the gear housing 71 supports an upper side bearing 741 and a lower side bearing 742 of the output shaft 75. The reduction gear unit 72 has a motor gear 731 and a reduction gear 732 which are in mesh with each other and formed by bevel gears. The motor gear 731 is integrally mounted to the motor shaft 65 so that it may rotate together with the motor shaft 65.

The reduction gear 732 is integrally mounted to the output shaft 75 so that it may rotate together with the output shaft 75. The motor gear 731 and the reduction gear 732 are formed as bevel gears as noted above. As compared with the motor gear 731, the reduction gear 732 has a greater number of teeth. Thus, the rotational drive of the motor gear 731 is rescued in speed and transmitted to the reduction gear 732. That is, the reduction gear 732 is in mesh with the motor gear 731, reduces in speed the rotational drive of the motor shaft 65 and transmits the rotational drive to the output shaft 75. The output shaft 75 to which the rotational drive is transmitted rotates the circular grinding wheel B mounted thereto to provide a rotational output.

The output shaft 75 is rotatably supported by the upper side bearing 741 and the lower side bearing 742. The upper side bearing 741 and the lower side bearing 742 are formed by ball bearings. The circular grinding wheel B as an end tool is mounted to the lower end of the output shaft 75. This grinding wheel B is mounted to the output shaft 75 via the clamp mechanism 37. This grinding wheel B rotates together with the output shaft 75. By pressing the front side portion C of the grinding wheel B against a grinding object, the grinding wheel B grinds the grinding object. Also with the disc grinder 10B of the fourth embodiment, the battery attachment portion 17A is set at a position closer to the output shaft 75 than the handle portion 15A.

With the disc grinder 10B of the fourth embodiment, it is possible to position the center of gravity of the rechargeable batteries 90 attached to the battery attachment portion 17A closer to the output shaft 75 than the handle portion 15A. As a result, it is possible to position the center of gravity of the brushless DC motor 62 and the center of gravity of the rechargeable batteries 90 close to the output shaft 35 in that order. Thus, it is possible to position the center of gravity of the tool close to the grinding position of the rotating grinding wheel B, and to make it easier for the front side portion C of the grinding wheel B to be applied to the grinding object, making it possible to improve the operability of the tool.

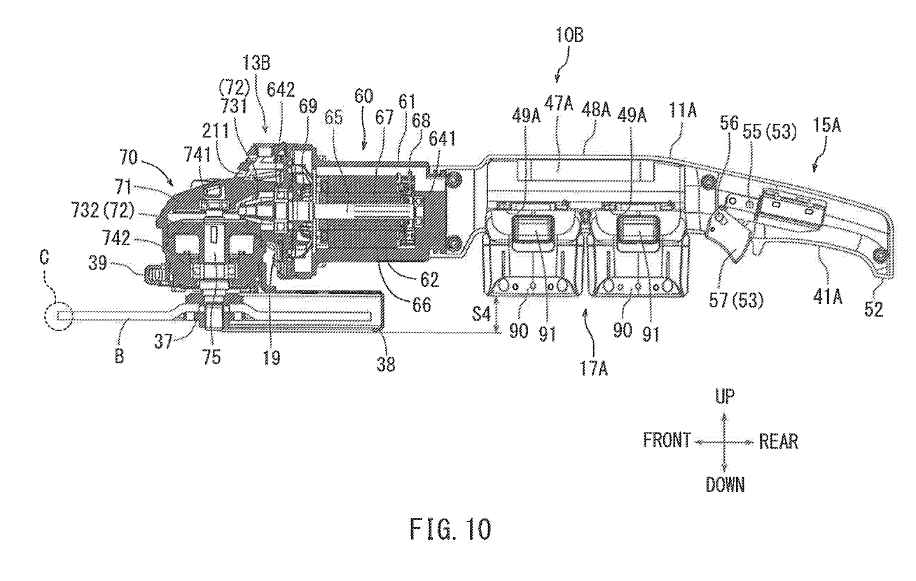

Further, with the disc grinder 10B of the fourth embodiment described above, there is a distance S4 shown in FIG. 10 between the lower ends of the attached rechargeable batteries 90 and the lower end of the disc grinder 10. As a result, the position in the vertical direction of the handle portion 15A set at the rear portion of the tool main body 11 can be easily changed, making it possible to improve the tool operability during the grinding operation.

The electric tool is not limited to a disc grinder as described above, but the constructions of the above-described embodiments can be applied as appropriate to any hand-held type electric tool. That is, the electric tool is not limited to a disc grinder as described above, but is applicable to various hand-held type electric tools such as a disc sander, a polisher, and a multi-tool performing various operations such as grinding, polishing, and burnishing.

Further, the rechargeable battery is not limited to the rechargeable battery 90 of the above embodiments but can be replaced by any other rechargeable battery designed to provide an appropriate voltage. Further, while in the embodiments described above two rechargeable batteries 90 are set, this should not be limited, and the number of rechargeable batteries may be set to one or three or four.

1. An electric tool comprising:
a battery attachment portion configured such that a rechargeable battery is attached to the battery attachment portion through sliding;
an electric motor configured to rotationally drive a motor shaft with a supply of electric power from the rechargeable battery; and
a reduction gear configured to reduce in speed the rotational drive of the motor shaft and to transmit the rotational drive to an output shaft to which working tool is mounted,
wherein the electric motor and the reduction gear are arranged such that a rotational axis of the motor shaft and a rotational axis of the output shaft extends substantially in a same direction.

2. The electric tool according to claim 1, wherein the electric motor is an outer rotor type motor.

3. The electric tool according to claim 1, wherein the electric motor is a brushless motor.

4. The electric tool according to claim 1, wherein the electric tool comprises a plurality of battery attachment portions that are arranged side-by-side; and
each of the plurality of the battery attachment portions is configured such that the rechargeable battery is attached through sliding in a direction parallel to the direction in which the motor shaft extends.

5. The electric tool according to claim 1, wherein the electric tool further comprises:
a handle portion disposed between the electric motor and the battery attachment portion; and
a vibration isolation rubber provided between a motor housing configured to support the electric motor and a handle housing of the handle portion.

6. The electric tool according to claim 1, wherein a first end of each of the motor shaft and the output shaft is supported by a motor housing via a first bearing, and a second end opposite to the first end of each of the motor shaft and the output shaft is supported by a gear housing via a second bearing.

7. An electric tool comprising:
a battery attachment portion configured such that a rechargeable battery is attached to the battery attachment portion through sliding;
an electric motor configured to rotationally drive a motor shaft with a supply of electric power from the rechargeable battery; and
a handle portion configured to be grasped by a user wherein:
the electric motor is positioned to be closer to an output than the battery attachment portion, the output shaft being configured to be capable of mounting a working tool thereto; and
the battery attachment portion is positioned closer to the output shaft than the handle portion.

8. The electric tool according to claim 7, wherein:
the electric tool comprises a plurality of the battery attachment portions that are arranged side-by-side; and
each of the plurality of battery attachment portions is configured such that the rechargeable battery is attached through sliding in a direction perpendicular to a direction in which the motor shaft extends.

9. The electric tool according to claim 7, the electric tool comprises a plurality of the battery attachment portions that are arranged side-by-side, and wherein each of the plurality of battery attachment portion is configured such that the rechargeable battery is attached through sliding in a direction perpendicular to a direction in which the handle portion extends.

10. The electric tool according to claim 7, wherein:
the handle portion is provided with an operation switch; and
the operation switch is a trigger type switch configured to allow a pulling operation by a user while the handle portion is grasped by the user.
